(19) United States
(12) Patent Application Publication
(10) Pub. No.: US 2008/0047892 A1
(43) Pub. Date: Feb. 28, 2008

(54) PORTABLE MICRO BLOOD SEPARATOR

(75) Inventors: Duck-jong Kim, Yuseong-gu (KR); Yun-wook Hwang, Yuseong-gu (KR); Yu-chang Kim, Yuseong-gu (KR); Sang-jin Park, Yuseong-gu (KR); Pil-woo Heo, Yuseong-gu (KR); Eui-soo Yoon, Yuseong-gu (KR); Yon-chan Ahn, Uiwang-si (KR); Jun-oh Ryu, Anyang-si (KR)

Correspondence Address: OBLON, SPIVAK, MCCLELLAND MAIER & NEUSTADT, P.C., 1940 DUKE STREET, ALEXANDRIA, VA, 22314, US

(73) Assignees: Korea Institute of Machinery & Materials, Yuseong-gu (KR); All Medicus Co., Ltd., Anyang-si (KR)

(21) Appl. No.: 11/691,086

(22) Filed: Mar. 26, 2007

(30) Foreign Application Priority Data
Aug. 25, 2006 (KR) 10-2006-0081280

(51) Int. Cl. B01D 35/06; B01D 29/00

(52) U.S. Cl. 210/243; 210/251

(57) ABSTRACT

Disclosed is a portable micro blood separator, which has a blood separator including a main body including an upper substrate and a lower substrate; a blood introduction unit formed at one side of the main body for allowing blood to be introduced into the separator; a blood inflow unit including an inflow groove formed in the lower substrate, through which the blood introduced by the blood introduction unit flows; and a plasma extraction unit including extraction spaces extended from the blood inflow unit and having a height lower than that of the inflow groove of the blood inflow unit so that plasma can be separated from the blood flowing into the blood inflow unit, so as to separate the plasma and corpuscles from the blood and analyze ingredients in the separated plasma.

### BACKGROUND OF THE INVENTION

1. Field of the Invention

The present invention relates to a blood separator, and more particularly to a portable micro blood separator in which a designated component is separated from blood using a capillary phenomenon without using a separate power unit and the separated component is simply analyzed by an electrochemical method.

2. Description of the Related Art

As well known to those skilled in the art, in order to diagnose a person's state of health, a biochemical humor test, particularly, a biochemical blood test, has been widely carried out. At this time, it is difficult to detect kinds of ingredients in whole blood, for example, metabolic products, protein, fat, electrolytes, enzymes, antigens, antibodies, etc, and to measure the densities thereof in whole blood.

Thus, blood, which was sampled in advance, is separated by a centrifugal separator, and the separated plasma or serum is analyzed using an analyzer or a biosensor.

FIG. 1 is a schematic view of a conventional blood separator.

With reference to FIG. 1, a conventional blood separator includes a lower substrate 101 having a fine groove channel 102 formed therein, and an upper substrate (not shown) covering the lower substrate 101. A blood sampling unit 103, a separating unit 104, analyzing units 105, and transferring units 106 are sequentially installed in the channel 102.

The blood sampling unit 103 is provided with a blood sampling needle 103a having a hollow structure, which is pierced into the skin of a human body to supply blood to the lower substrate 101.

The separating unit 104 is obtained by bending a corresponding portion of the channel 102, and, for example, is made of a U-shaped micro-capillary.

Each of the analyzing units 105 includes a sensor for sensing the pH value of the blood, and the densities of oxygen, carbon dioxide, sodium, calcium, and protein contained in the blood.

The transferring units 106, which are located at the lowest portion of the channel 102, transfer the blood in micro-capillaries through an electro osmotic flow. Each of the transferring units 106 includes electrodes 107 and 108 and a channel portion 109 connecting the electrodes 107 and 108. A buffer solution, which filled the channel 102 in advance, is transferred to the lower portion of the channel 102 by the electro osmotic flow generated due to the application of a voltage between the electrodes 107 and 108, thus generating suction force. Thereby, blood is transferred from the blood sampling unit 103 at the front portion of the channel 102 to the substrate 101.

The above-described conventional blood separator samples blood, separates the blood into corpuscles and plasma using a centrifugal separator, and then carries out the analysis of blood components, thus requiring a large amount of blood.

Further, since the conventional blood separator requires the centrifugal separator and peripheral devices, such as electrodes for supplying blood into the channel, the conventional blood separator cannot be effectively used when an operator wants to rapidly analyze a small amount of blood or conducts a field test, and is not handy to carry.

### SUMMARY OF THE INVENTION

Therefore, the present invention has been made in view of the above problems, and it is an object of the present invention to provide a portable micro blood separator, in which blood is introduced into a blood introduction unit by a capillary phenomenon, and only a plasma component having a small size is extracted from the blood on a lower substrate of the blood introduction unit and is analyzed by an electrochemical method, thus simply and rapidly separating and analyzing blood without using a complicate peripheral device.

It is another object of the present invention to provide a portable micro blood separator, in which blood is separated towards spaces formed in a substrate by a capillary phenomenon without using a separate peripheral device and is then analyzed by an electrochemical method, thus being handy to carry.

In accordance with the present invention, the above and other objects can be accomplished by the provision of a portable micro blood separator, which has a blood separator including a main body including an upper substrate and a lower substrate; a blood introduction unit formed at one side of the main body for allowing blood to be introduced into the separator; a blood inflow unit including an inflow groove formed in the lower substrate, through which the blood introduced by the blood introduction unit flows; and a plasma extraction unit including extraction spaces extended from the blood inflow unit and having a height lower than that of the inflow groove of the blood inflow unit so that plasma can be separated from the blood flowing into the blood inflow unit, so as to separate the plasma and corpuscles from the blood and analyze ingredients in the separated plasma, comprising conductors having electric conductivity and respectively provided in the extraction spaces to analyze the ingredients of the extracted plasma by an electrochemical method using an electrochemical measuring instrument, wherein the plasma extraction unit is provided with enzyme injection holes.

The blood introduction unit includes an opening formed through the upper substrate, and an introduction groove formed in the lower substrate.

The inflow groove has a semicircular shape so that the plasma can be smoothly extracted from the blood by the plasma extraction unit.

A plurality of extraction spaces are disposed at the same interval in a radial shape centering on the blood introduction unit.

Each of the conductors includes an operating electrode providing a space, where the plasma reacts with an enzyme, and receiving a voltage applied from an electronic part for applying voltage and measuring current; and a reference electrode formed correspondingly to the operating electrode and receiving a reference voltage applied from the electronic part for applying voltage and measuring current. Thereby, an external measuring instrument can detect a variation of current due to the reaction of the plasma with the enzyme.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional blood separator;

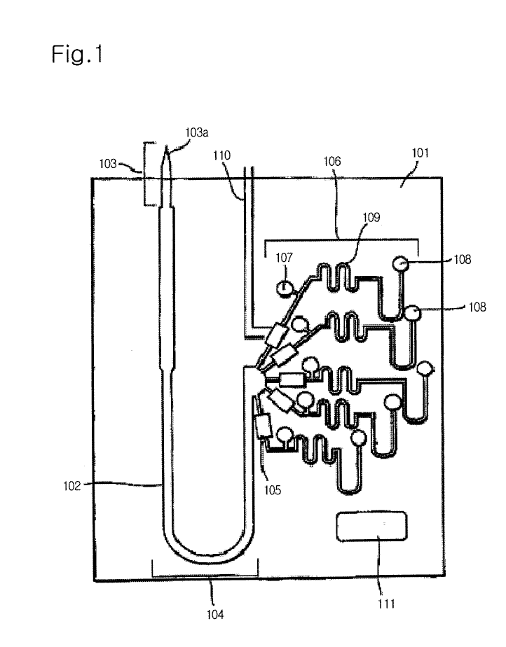

FIG. 2 is a perspective view of a portable micro blood separator in accordance with one embodiment of the present invention;

FIG. 3 is an exploded perspective view of the portable micro blood separator of FIG. 2;

FIG. 4 is a schematic view of a conductor of the portable micro blood separator in accordance with one embodiment of the present invention;

FIG. 5 is a plan view of a portable micro blood separator in accordance with another embodiment of the present invention; and

FIGS. 6A to 6C are graphs respectively representing analysis results of plasma separated from blood using portable micro blood separators in accordance with various embodiments of the present invention.

### DESCRIPTION OF THE PREFERRED EMBODIMENTS

Now, preferred embodiments of the present invention will be described in detail with reference to the annexed drawings.

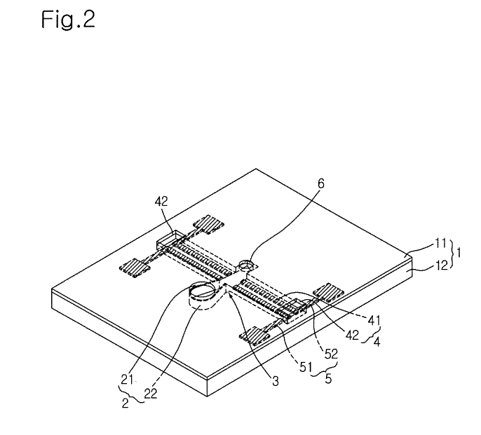

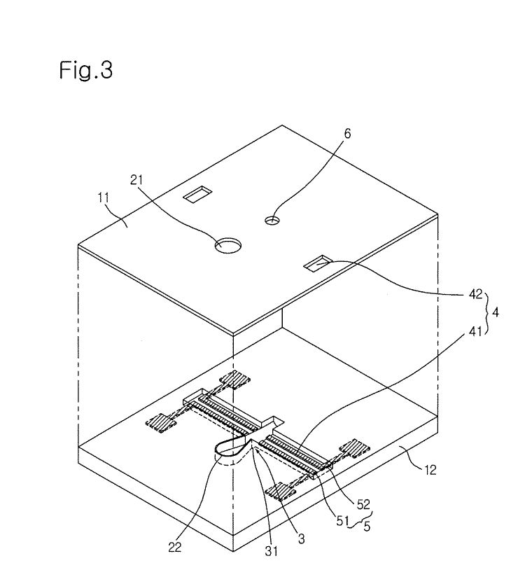

FIG. 2 is a perspective view of a portable micro blood separator in accordance with one embodiment of the present invention, and FIG. 3 is an exploded perspective view of the portable micro blood separator of FIG. 2. As shown in FIGS. 2 and 3, a portable micro blood separator in accordance with one embodiment includes a main body 1, a blood introduction unit 2, a blood inflow unit 3, a plasma extraction unit 4, and conductors 5.

The main body 1 includes an upper substrate 11 and a lower substrate 12, and carries out the component analysis of the blood using a separate blood measuring instrument (not shown).

The blood introduction unit 2 is formed at one side of the main body 1, and allows blood to be introduced into the separator therethrough. The blood introduction unit 2 includes an opening 21 formed through the upper substrate 11, and an introduction groove 22 formed in the lower substrate 12.

The blood inflow unit 3 includes an inflow groove 31 formed in the lower substrate 12, through which the blood introduced by the blood introduction unit 2 flows.

The inflow groove 31 has a semicircular shape so that plasma extracted from the blood can smoothly flow to the plasma extraction unit 4. Preferably, although not shown in the drawings, the upper ends of both sides of the inflow groove 31 are rounded so as not to damage the extracted plasma.

The plasma extraction unit 4 includes extraction spaces 41 extended from the blood inflow unit 3, and enzyme injection holes 42 provided at the ends of the extraction spaces 41.

Preferably, the plasma extraction unit 4 has a height lower than that of the inflow groove 31 of the blood inflow unit 3 so that plasma can be separated from the blood flowing into the blood inflow unit 3.

Thereby, plasma or serum, except for components having a large diameter, such as corpuscles, is extracted from the blood flowing into the blood inflow unit 3 by the extraction spaces 41.

The conductors 5 are respectively provided in the extraction spaces 41 so as to analyze the extracted plasma in the extraction spaces 41 using an electronic part for applying voltage and measuring current, and have electric conductivity so as to analyze ingredients of the plasma, which reacts with an enzyme injected through the enzyme injection holes 42.

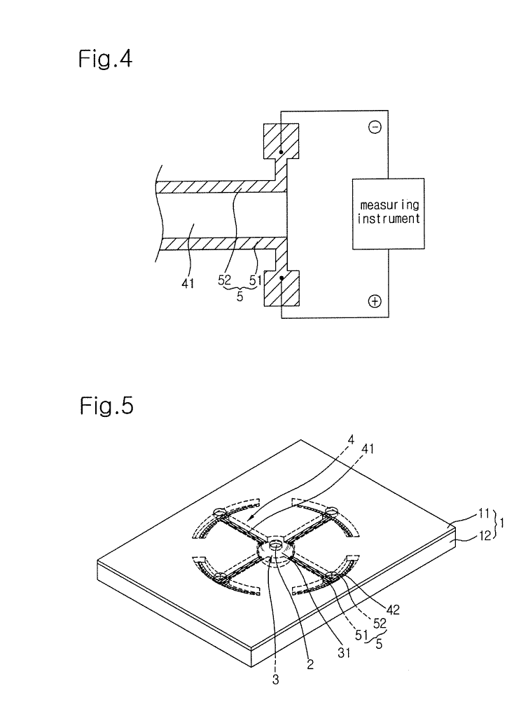

FIG. 4 is a schematic view of a conductor of the portable micro blood separator in accordance with one embodiment of the present invention. With reference to FIG. 4, the conductor 5 includes an operating electrode 51 providing a space, where plasma reacts with an enzyme, and receiving a voltage applied from an electronic part for applying voltage and measuring current, and a reference electrode 52 formed correspondingly to the operating electrode 51 and receiving a reference voltage applied from the electronic part for applying voltage and measuring current.

Accordingly, when the electronic part for applying voltage and measuring current applies designated voltages respectively to the operating electrode 51 and the reference electrode 52, there is a variation of current due to ingredients in the plasma. Then, an external measuring instrument detects and analyzes the variation of current, thus analyzing the ingredients in the plasma.

A technique of detecting ingredients by an electrochemical method using the above conductor 5 is well known prior to the invention, and a detailed description thereof will thus be omitted because it is considered to be unnecessary.

The portable micro blood separator of the present invention may further include a blood induction unit 6, which is formed at the end of the blood inflow unit 3 opposite to the blood introduction unit 2. The blood induction unit 6 induces the blood to flow from the blood introduction unit 2 to the blood inflow unit 3 by a capillary phenomenon.

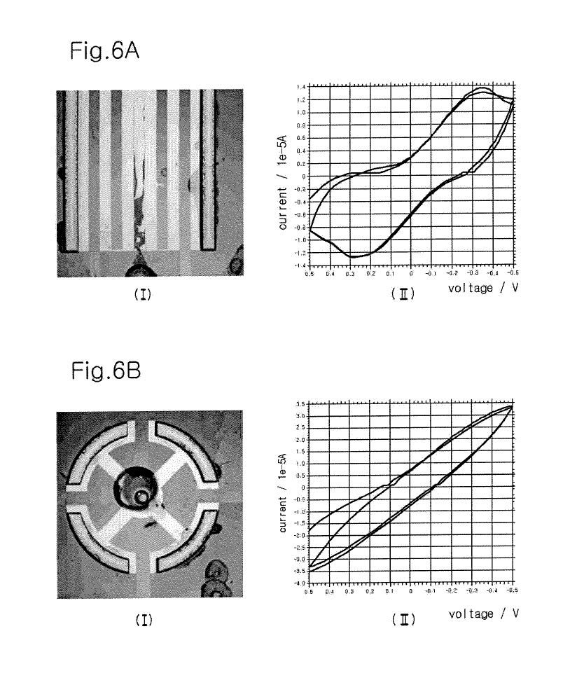

FIG. 5 is a plan view of a portable micro blood separator in accordance with another embodiment of the present invention. Some parts in this embodiment are substantially the same as those in the earlier embodiment, and a detailed description thereof will thus be omitted because it is considered to be unnecessary.

In accordance with another embodiment, the plasma extraction unit 4 includes a plurality of extraction spaces 41, which are extended and disposed at the same interval in a radial shape centering on the blood introduction unit 2, enzyme injection holes 42, which are respectively provided at the ends of the extraction spaces 41, and the conductors 5 are respectively provided in the plurality of extraction spaces 41.

In the embodiments of the present invention, since the plurality of extraction spaces 41 are formed, it is possible to analyze a plurality of ingredients in the plasma using a single separator.

That is, the conductors 5 and the enzyme injection holes 42 are respectively formed at the plurality of extraction spaces 41. Accordingly, by injecting different enzymes into the extraction spaces 41 according to ingredients of the plasma to be analyzed, different kinds of ingredients can be analyzed using a single separator. Thereby, it is possible to improve the analyzing efficiency of the separator.

Although the embodiments of the present invention disclose the plasma extraction unit including extraction spaces extended from the blood inflow unit in a straight line or in a radial shape, the plasma extraction unit may include extraction spaces disposed in various shapes.

Hereinafter, the function of the portable micro blood separator of the present invention will be described.

First, an enzyme, which reacts with a target to be analyzed, is injected through the enzyme injection holes 42, and is dried.

Thereafter, sampled blood is dropped into the introduction groove 22 through the opening 21 of the blood introduction unit 2.

Thereafter, the blood introduced into the introduction groove 22 flows to the inflow groove 31 of the blood inflow unit 3 by a capillary phenomenon.

Among the blood in the inflow groove 31, corpuscle components having a large size remain in the inflow groove 31, and a plasma or serum component having a small size is separated from other components of the blood by the capillary phenomenon, is extracted by the extraction spaces 41 extended from the inflow groove 31, and then reacts with the dried enzyme.

When the plasma is extracted, ingredients in the plasma are analyzed by an electrochemical analyzing method, in which a variation of current due to the plasma reacting with the enzyme is detected by applying designated voltages to the conductors 5, i.e., by respectively applying an operating voltage to the operating electrodes 51 and a reference voltage to the reference electrodes 52, using the electronic part for applying voltage and measuring current. Thereby, ingredients in the plasma can be analyzed.

Specifically, the enzyme reacting with a target to be analyzed is injected into the extraction spaces 41 through the enzyme injection holes 42, and is dried. Thereafter, when the plasma is extracted by the extraction spaces 41, voltages are applied to the conductors 5. Then, the extracted plasma reacts with the enzyme, thus generating a current.

Since the current generated by the reaction of the plasma with the enzyme relates the density of the target to be analyzed, the density of the target is detected by measuring the current.

Here, a material causing an oxidation-reduction reaction with a target, the density of which is measured, is used as the enzyme injected into the enzyme injection holes 42.

For example, glucose oxidase or glucose dehydrogenase (GDH) is used as an enzyme for analyzing glucose. The enzyme injected into the enzyme injection holes 42 is not limited thereto, but may use any material, which can cause an oxidation-reduction reaction with the target.

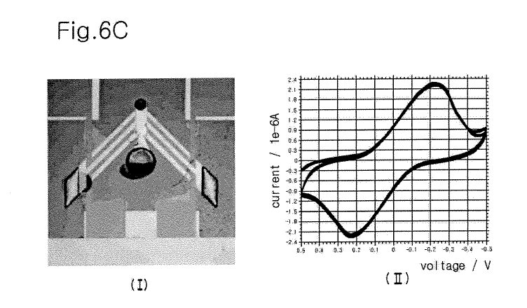

FIGS. 6A to 6C are graphs respectively representing analysis results of plasma separated from blood using portable micro blood separators in accordance with various embodiments of the present invention.

With reference to FIGS. 6A to 6C, (I) illustrates a shape of electrodes of the corresponding portable micro blood separator, and (II) is a graph representing a variation of current according to applied voltages. Here, cyclic voltammetry (CV) out of electrochemical methods is used.

When an enzyme injected through enzyme injection holes contacts an ingredient in plasma, an oxidation-reduction reaction therebetween occurs. Current flowing along the conductors is increased or decreased due to the oxidation-reduction reaction and the applied voltages. Then, the peak value of current flowing along the conductors is detected, and the amount of the ingredient of plasma is calculated based on the peak value.

The detected peak value of current varies according to shapes and sizes of conductors, i.e., electrodes. Thus, in order to improve blood analysis characteristics of the portable micro blood separator, it is necessary to optimize the shapes and sizes of the electrodes.

As described above, a portable micro blood separator of the present invention separates plasma from blood using a capillary phenomenon, and analyzes ingredients in the separated plasma by an electrochemical method, in which the plasma reacts with an enzyme, thus simply achieving the separation of a small quantity of blood and being handy to carry.

As apparent from the above description, the present invention provides a portable micro blood separator, in which blood is introduced into a blood introduction unit by a capillary phenomenon, and a plasma component having a small size is extracted from the blood on a lower substrate of the blood introduction unit and is analyzed by an electrochemical method, thus simply and rapidly separating and analyzing blood without using a complicate peripheral device.

Further, the portable micro blood separator of the present invention, which separates the plasma from the blood towards spaces formed in the substrate without using the peripheral device and analyzes the plasma by the electrochemical method, is handy to carry, thus being available for use in a blood test regardless of time and space.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A portable micro blood separator, which has a blood separator including a main body including an upper substrate and a lower substrate; a blood introduction unit formed at one side of the main body for allowing blood to be introduced into the separator; a blood inflow unit including an inflow groove formed in the lower substrate, through which the blood introduced by the blood introduction unit flows; and a plasma extraction unit including extraction spaces extended from the blood inflow unit and having a height lower than that of the inflow groove of the blood inflow unit so that plasma can be separated from the blood flowing into the blood inflow unit, so as to separate the plasma and corpuscles from the blood and analyze ingredients in the separated plasma, comprising:
conductors having electric conductivity and respectively provided in the extraction spaces to analyze the ingredients of the extracted plasma by an electrochemical method using an electrochemical measuring instrument,
wherein the plasma extraction unit is provided with enzyme injection holes.

2. The portable micro blood separator according to claim 1, wherein the blood introduction unit includes an opening formed through the upper substrate, and an introduction groove formed in the lower substrate.

3. The portable micro blood separator according to claim 1, wherein the inflow groove has a semicircular shape so that the plasma can be smoothly extracted from the blood by the plasma extraction unit.

4. The portable micro blood separator according to claim 1, wherein a plurality of extraction spaces are disposed at the same interval in a radial shape centering on the blood introduction unit.

5. The portable micro blood separator according to claim 1, wherein each of the conductors includes:
an operating electrode providing a space, where the plasma reacts with an enzyme, and receiving a voltage applied from an electronic part for applying voltage and measuring current; and
a reference electrode formed correspondingly to the operating electrode and receiving a reference voltage applied from the electronic part for applying voltage and measuring current.

6. The portable micro blood separator according to claim 2, wherein each of the conductors includes:
an operating electrode providing a space, where the plasma reacts with an enzyme, and receiving a voltage applied from an electronic part for applying voltage and measuring current; and
a reference electrode formed correspondingly to the operating electrode and receiving a reference voltage applied from the electronic part for applying voltage and measuring current.

7. The portable micro blood separator according to claim 3, wherein each of the conductors includes:
an operating electrode providing a space, where the plasma reacts with an enzyme, and receiving a voltage applied from an electronic part for applying voltage and measuring current; and
a reference electrode formed correspondingly to the operating electrode and receiving a reference voltage applied from the electronic part for applying voltage and measuring current.

8. The portable micro blood separator according to claim 4, wherein each of the conductors includes:
an operating electrode providing a space, where the plasma reacts with an enzyme, and receiving a voltage applied from an electronic part for applying voltage and measuring current; and
a reference electrode formed correspondingly to the operating electrode and receiving a reference voltage applied from the electronic part for applying voltage and measuring current.
